(19) United States
(12) Patent Application Publication
(10) Pub. No.: US 2006/0274395 A1
(43) Pub. Date: Dec. 7, 2006

(54) Printer Driver Including Supply-Ordering Capability

(76) Inventors: Anthony Harris, Newbury (GB); Duncan Webb, Didcot (GB); Paul Winwood, Abingdon (GB); Craig Graw, Swindon (GB)

Correspondence Address: FOLEY HOAG, LLP;PATENT GROUP, WORLD TRADE CENTER WEST, 155 SEAPORT BLVD, BOSTON, MA, 02110, US

(21) Appl. No.: 11/380,316

(22) Filed: Apr. 26, 2006

Related U.S. Application Data
(63) Continuation of application No. 09/787,117, filed on Jun. 29, 2001, now abandoned.

(30) Foreign Application Priority Data
Sep. 18, 1998 (GB) 9820401.9

(51) Int. Cl. G06E 3/00

(52) U.S. Cl. 359/107

(57) ABSTRACT

A device driver, for generating control commands for driving a peripheral, includes a status store configured to store state data, which identifies a current state for each of a number of functions of a peripheral. The device driver also includes a driver engine that is operable to generate control commands for driving a peripheral in accordance with state data stored in the status store. The device driver further includes a user interface generation module for generating display data that defines graphical user interface displays in dependence upon data stored in the status store and is responsive to user selection of graphical elements in generated user interface displays to update data stored in said status store. The user interface generation module includes a graphics store configured to associate each state of each of said number of functions of a peripheral with an item of graphics data defining a graphical element. The user interface generation module also includes a page store configured to store a user interface template, which includes layout data defining an arrangement of place markers for graphical elements of a display and data associating at least some of said place markers with functions of a peripheral. The user interface peripheral also includes a display data generation module responsive to the updating of data in the status store to generate display data defining a graphical user interface display. The graphical user interface display includes graphical elements defined by graphics data associated with states identified by state data in the status store for functions associated with place markers by the user interface template. The graphical elements are arranged in accordance with the layout data of the user interface template.

### CROSS-REFERENCES TO RELATED APPLICATIONS

This applications claims the benefit under 35 U.S.C. § 120 as a continuation application of U.S. non-provisional application Ser. No. 09/787,117, filed Jun. 29, 2001 entitled “Printer Driver Including Supply-Ordering Capability,” which in turn claims the benefit of PCT/GB99/03199 filed Sep. 20, 1999, which in turn claims priority to GB9820401.9 filed Sep. 18, 1998.

### BACKGROUND

Personal computers may typically be interfaced to a number of peripherals such as printers, modems, scanners and the like. Each of these peripherals may be configurable in different manners (e. g. a printer may be able to print at various resolutions). Furthermore each peripheral may have different capabilities in comparison to peripherals of the same type (e.g. a printer may or may not be able to print in color). It is therefore necessary, in certain cases, for the user to be able to specify the configuration of the peripheral for the particular job in hand. This may also require different processing of the data before it is output to a peripheral. The output of this user defined configuration information to the peripheral and the necessary processing of the data before outputting to the peripheral is carried out by the device driver.

As stated above, device drivers perform in essence two functions, the first being to convert data from the form used by the computer to a form usable by the driven device. Their second function is to provide various command and control parameters to the driven device. Both the above functions are under the control of the user who communicates with the device driver via a user interface.

The Windows (Trademark) Graphical User Interface (GUI) is now the most commonly used user interface for personal computers. This GUI may be by way of an adjunct to the operating system (e.g. Windows 3.x and Windows 95/98) or be integral to the operating system (e.g. Windows NT). The Windows GUI causes controls to be displayed on the personal computer's display and these controls can be selected or varied using a pointing device, typically a mouse, in conjunction with one or more buttons for confirming that the control pointed at is to be selected. These controls may include buttons, radio buttons or sliders.

However, there is a lack of flexibility in a system designer's choice of controls, as a system designer is confined to a choice of a small number of different types of controls in the design of the user interface for a device driver. This choice may restrict the functionality that a designer is attempting to achieve. It also makes a device driver less “user friendly.” Although a developer may create Windows custom controls, these require a good working knowledge of Windows system programming.

A problem therefore arises as the present scheme of constructing a device driver is complex, offers little choice in how the display will appear to a user and the architecture available means that such construction requires very specialist skills.

The present invention addresses the above problem by providing a device driver architecture which contains two separate but related sets of data, the first set defining the functionality of the features of the driver and the second set, how those features will be presented by way of graphical interface. Such an architecture provides the designer of a device driver with increased flexibility in the design of the appearance of the user interface without affecting the functionality of the driver.

Additionally with the advent of Windows 98 and the Windows NT, it is desirable that the user's view of the system should be in the form of a browser interface such that the distinction between the user's view of the local machine and the World Wide Web may become amalgamated into one seamless view. The basis for defining such a user interface would be a hypertext based system as used over the Internet. HTML (Hyper Text Mark-up Language) is such a system which defines certain user interface mechanisms and conventions and is presently used across many platforms including Windows 95/98, Windows NT and UNIX based systems.

There remains a problem within the field of device drivers in that they continue to adhere to the legacy conventions of earlier operating systems and do not make use of the facilities offered by the newer systems. HTML technology allows many user interfaces which each have their own look and feel to be created using the same underlying structure which is in itself heavily extensible. The invention brings the appearance of a device driver interface into line with that which any user who has browsed the web will be familiar with.

### SUMMARY OF THE INVENTION

The present invention provides a device driver for interfacing a personal computer to a peripheral, the device driver comprising: a device driver engine for driving the peripheral in accordance with control commands; means for defining a plurality of elements, each element having at least one state, each state having an associated image for display to a user for user selection and at least one of a pointer to one or more associated elements or a control command to be output to the device driver engine; means for defining a plurality of pages, each page being associated with a state of an element and listing at least one of said one or more associated elements; and means for (i) receiving a user selection of a current state of a current element; (ii) reading the page associated with the current state of the current element; (iii) generating a display using the associated image of each element identified in the page list for the current state of the current element; and (iv) outputting the control command, if any, of the current state of the current element to the device driver engine.

### BRIEF DESCRIPTION OF THE DRAWINGS

An embodiment of the invention will now be described with reference to the accompanying figures in which:

FIG. 1 shows a computer system including a personal computer and peripherals including a printer and a modem;

FIG. 2 is a simplified block diagram of a printer driver according to the embodiment of the present invention;

FIG. 3 is a simplified diagram showing a hierarchical structure of a set of elements forming part of the printer driver shown in FIG. 2;

FIG. 4 is a simplified diagram showing the data structure defining the ink options element shown in FIG. 3;

FIG. 5 is a simplified diagrammatic representation of a home page output as it would appear to the user of a printer driver according to the embodiment of the invention;

FIG. 6 is a simplified diagrams showing the data structure defining the home page;

FIG. 7 is a simplified memory map of the working memory of the I/O interface shown in FIG. 2;

FIG. 8 is a much simplified flow diagram which illustrates the I/O interface of the printer driver according to the embodiment of the invention;

FIG. 9 is a flow diagram showing the events triggered by a single click of the left mouse button;

FIG. 10 is a simplified diagrammatic representation of a screen output page as it would appear to the user following a selection of the color ink element of FIG. 5 using a single click of the left mouse button;

FIG. 11 is a flow diagram showing the events triggered by a double click of the left mouse button;

FIG. 12 is a simplified diagrammatic representation of a screen output page as it would appear to the user following a selection of the color ink element of FIG. 5 using a double click of the left mouse button;

FIG. 13 is a simplified diagrammatic representation of a screen output page as it would appear to the user following a selection of the color ink element of FIG. 10 using a double click of the left mouse button; and

FIGS. 14A and 14B are a flow diagram of the events triggered by a single click of the right mouse button.

### DETAILED DESCRIPTION

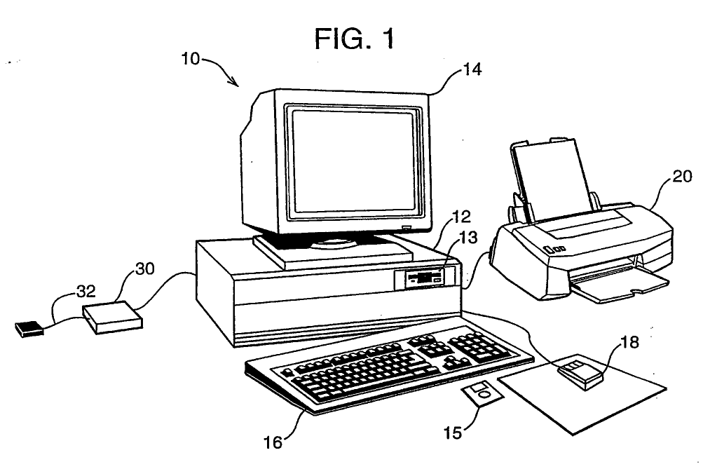

FIG. 1 shows a personal computer 10 comprising a processor unit 12, a visual display unit (VDU) 14, a keyboard 16 and a pointing device which in this embodiment is a mouse 18. In this embodiment the mouse has two buttons to allow the user to confirm a selection, namely a right and a left button. The need for two buttons will be described in more detail below. The processor unit 12 includes a floppy disc drive 13, which may read a floppy disc 13a in addition to the usual components of RAM, ROM, CPU, hard disc and the like (not shown). Connected to the personal computer system 10 are two peripherals, namely printer 20 and a modem 30. The modem is connected to a telephone line (not shown) using cable 32. The personal computer system 10 can, therefore, communicate with outside devices such as the Internet. In this embodiment, the printer 20 is a color ink jet printer.

The processor unit 12 is effective to run under the command of software instructions which are stored in the RAM of the unit. A group of these instructions form the printer driver. This software may initially be provided upon a floppy disc 15 (or other storage medium) or downloaded from a data network (e.g. from the Internet) via modem 30.

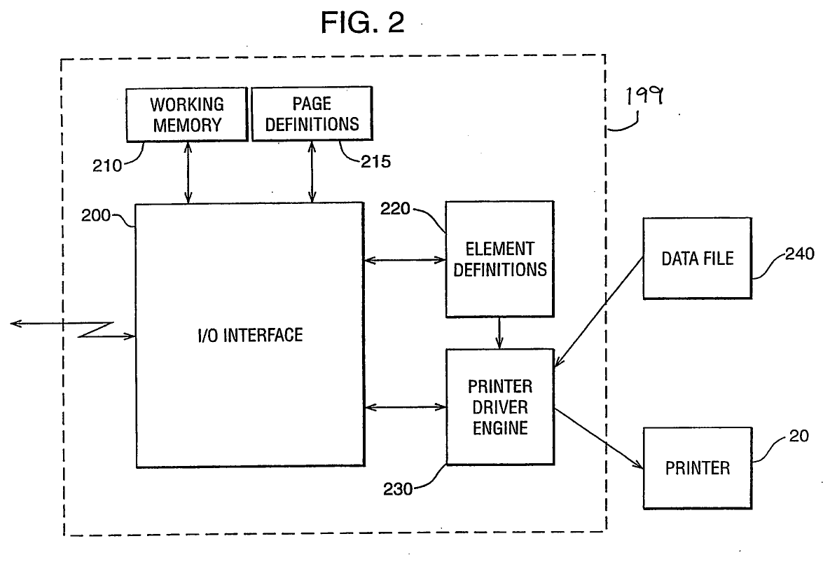

FIG. 2 is an overall block diagram of the printer driver 199 oft 's embodiment together with the printer 20 and a data file 240 to be printed. The printer driver engine 230 is set of software instructions which instruct the CPU on the process which it must conduct in order to convert the data file 240 so that it can be interpreted by he printer 20.

The type of co version process to be performed by the printer driver engine 230 and other of its general functions are under the control of I/O interface 200. This I/O interface 200 is a set of software instructions which attend t input and output to and from the user (via the keyboard 16, mouse 18 and the display 14 previously described) and pass control parameters to the printer driver engine 230 in accordance with the user's input. The I/O interface performs the above operations in accordance with two predefined groups of data, the first of which s a group of element definitions 220 and the second of which is a group of page definitions 215, both of which ill be described more fully below. In overview, however, elements contain the control information for the printer driver engine whereas pages contain information on how that control information should be displayed to a user.

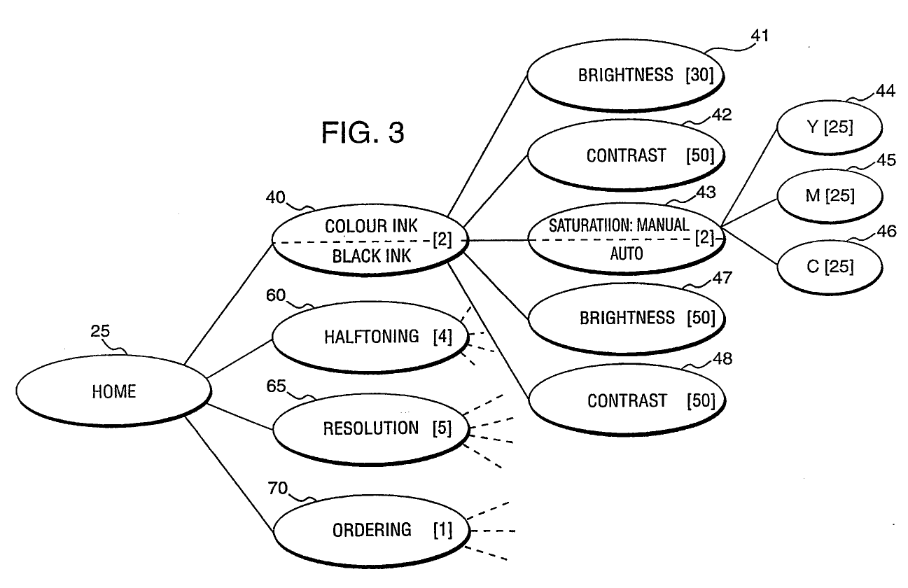

Further details of the element definitions 220 will be described with reference to FIG. 3 which shows a number of such elements. As will be seen from the Figure these element definitions are interconnected in a hierarchical manner. A number of the elements (which can conveniently be termed branch elements) act as a passage to one or more children, an example of such an element being color/black ink element 40. Elements at the bottom of the hierarchy (which can conveniently be termed leaf elements) determine a printer action, that is to say they are effective to control the printer driver engine 230. In FIG. 3, the home element 25 is positioned on the far left of the Figure and represents the overall “parent” element. In the embodiment, the home element 25 has a single state and has four children, namely a color/black ink element 40, a halftone element 60, a resolution element 65 and an ordering element 70. All these elements have multiple states as indicated by a numeral in square brackets in the element.

Color/black ink element 40 is effective, via its children, to set: the ink type options for the printer 20, that is to say, whether the printer will print using plural color inks or only black ink.

Both states of the color/black ink element 40 are shown explicitly in the Figure from which it will be seen that the children off this element are dependent upon its state. The element 40 has three children in its color ink state (elements 41-43) and two (different) children (elements 47 & 48) in its black ink state. In the color state, these children are brightness element 41, contrast element 42 and saturation element 43. Of these three elements, the brightness element 41 and contrast element 42 are: Leaf elements in all states as they have no subsequent children. Saturation element 43, has two states, namely manual (state 0) and automatic (state 1). In its manual state it has three children, yellow element 44, magenta element 45 and cyan element 46. In its automatic state it has no children. It will thus be noted that an element may be of a hybrid nature, that is to say, a branch element in some states and a leaf element in others.

It will be appreciated that certain elements have a large number of states (e.g. the color contrast element which has 50 states). In the embodiment, this is displayed by presenting a graphic the content of which varies as it is clicked on, i.e. as the states are cycled through. However, in a modification, such an element could be implemented by fewer states each representing intermediate values such as 25%, 50%, 75% and 100% (0% being in this case of no practical use) with a further state for a custom setting which may be entered via the keyboard. Such a modification may be preferable in the case of an element having a high number of states in particular one exceeding 100 states to avoid a user needing to click on an element an excessive number of times. Furthermore, as an alternative to keyboard entry of the custom setting, this could have a child element having the multiple states so that no recourse to the keyboard is necessary.

The Halftoning element 60 is used to allow the setting of various halftoning options (e.g. ordered dither, error diffusion and the like). The Resolution element 65 is used to allow the setting of various printer resolutions, usually expressed in dots per inch (dpi) for example, 300 dpi, 600 dpi etc. The Ordering element 70 allows the ordering of printer orientated supplies via the Internet (e.g. paper, ink and the like).

This is achieved in the embodiment using identification information stored in the printer driver which is sent to the supplier when the ordering of supplies is selected. This identifies the type of printer as well as relevant configuration information for that specific printer (e.g. whether it has been upgraded in any manner) Additionally, the printer driver may be pre-programmed with the address of a suitable supplier which may be the manufacturer.

As the device driver is peripheral specific, these supplies can be specific to the peripheral. This information, to give an example, will ensure that the correct ink for the printer will be ordered. Furthermore, this facility will also allow a user to order new printer models from the manufacturer or to upgrade hardware or software. In the case of a software upgrade this may be downloaded immediately over the Internet.

The above elements have an arrangement of children dependent upon their state in a similar manner to the color/black ink element and thus will not be described in detail. It will be appreciated that a number of other different printer options may also be accessible via appropriate elements, the four elements listed above being exemplary only.

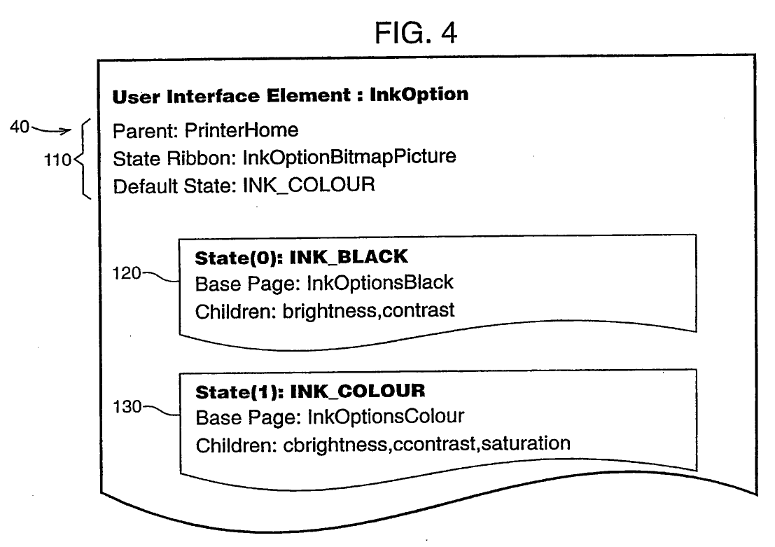

Each of the elements shown in FIG. 3, has its own element definition which contains details of its logical position relative to other elements that is to say it defines the above described hierarchical structure. The definition also contains the control information for the printer driver engine 230. This element definition will now be described with reference to FIG. 4 which shows by way of example the definition for the color/black ink element 40.

The element definition comprises two portions a basic definition portion 110 and a state definition portion 120, 130. In color/black ink element 40 there are two states and therefore two state definitions, one for color ink (state 1) 130 and another for black ink (state 0) 120.

In this embodiment, the basic definition portion 110 contains three pieces of information. The first is information concerning the parent of the element, which in the case of this element is the printer home element 25. The second piece of information is termed the “state ribbon” and contains a pointer to a series of images for display to the user. As described more fully below, this allows an image indicating the present state of the element to be presented to the user. This series contains an image for each state of the element in a sequential order. Thus in this case, there are two images, one for state 0 (black ink) and the other for state 1 (color ink). The final piece of information is the default state of the element being that which the printer driver is set upon first activation, in this case; the color state.

As previously described, this element has two states and thus two state definition sections 120, 130. In the black ink definition 120 (state 0), is information defining the “base page” associated with that state, in this case ink-options-black. This base page information is used in determining the user interface display in a manner which will be described later. Also defined in the state definition 120 are the children associated with that state, in this case brightness element 47 and contrast element 48. As will be appreciated, each of these children will have an element definition of its own.

Similarly, in the color ink state definition 130 comprises information defining its base page (ink-options-color) and its children (C-brightness element 41, C-contrast element 42 and saturation element 43).

It should be noted that the element definition does not differentiate whether these children are leaf elements or whether they have subsequent children themselves.

In a leaf element (e.g. brightness element 47) the state definition will not include a list of children but instead will include command data to be passed to the printer driver e give 230 corresponding to the action to be performed.

As has been explained above, the user interface structure is defined by a group of element definitions. These definitions are, however, separate from a group of page definitions which define how the information will be presented to the user on the VDU 14.

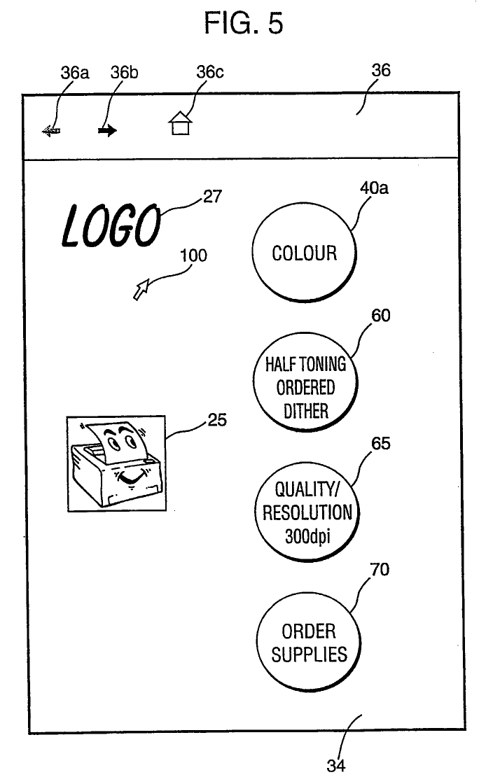

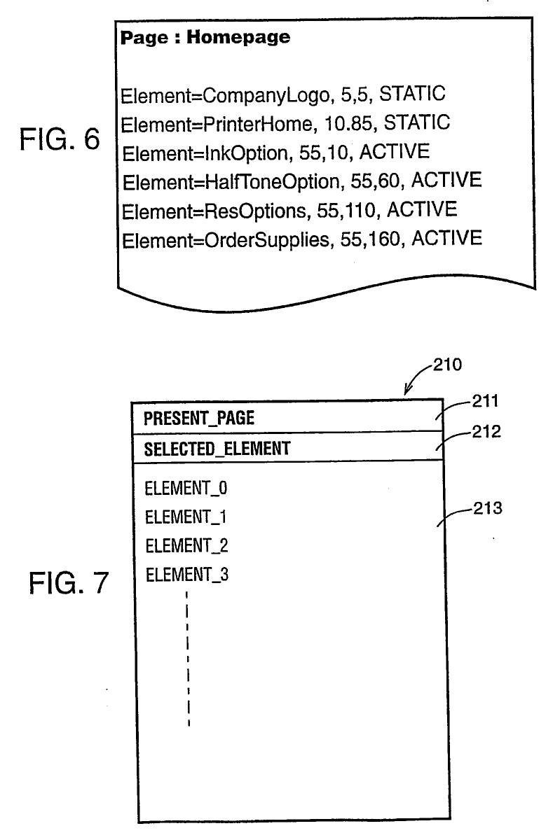

These page definitions will now be described with reference to FIGS. 5 and 6.

FIG. 5 shows the home page of the user interface, being that which is displayed to a user upon selection of the printer driver. The display comprises essentially two parts and is in certain respects similar to a web browser. These two parts are the tool bar 36 for navigating around the driver and the browsing space 34 in which a variety of elements can be displayed. The tool bar 36 has a backward arrow 36a and forward arrow 36b for navigating through the hierarchical structure of the driver and home control 36c which will return the browsing space 34 to the home page. In the Figure, back arrow 36a is presently deactivated because the browsing space is presently on the home page. The arrow is therefore grayed which is a known technique to indicate that the option cannot be selected.

Cursor 100 can be moved around the browsing space 34 by movement of the mouse 18. In the browsing space 34 are images representing the functional elements which can be accessed, in this case, color/black ink element 40a, halftoning element 60, quality resolution element 65 and order supplies element 70. As will be seen, three of these are elements which have multiple states and an image corresponding to the current state is displayed. Two static elements, printer image 25 and logo image 27 which cause no function to be performed but are definable by the device manufacturer and may therefore be tailored to its house style are also displayed. In the figure the images are shown diagrammatically as areas having printed labels but they will preferably be images indicative of the function. For example, the image showing the state of the color element 40a could display a rainbow of colors or a pie chart showing different colors or the like.

FIG. 6 shows the page definition of the home page shown in FIG. 5. This definition includes a list of elements to be displayed, the list including the name of the element, the X, Y coordinates at which it should be displayed on the VDU and whether that element is static, active or grayed. It will therefore be appreciated that any number of elements can be displayed on each page and each element can be placed at any position on the screen. As previously explained, each element may be specified as static, active or grayed for that particular page. A static or grayed element is one which is merely displayed but causes no action to occur. An active element is one which may be selected by the user and may act as a gateway to its children or cause an action to take place. It should be appreciated, however, that grayed and static elements are not equivalent. A static element remains so on all pages whereas a grayed element is only nonselectable on particular pages and will be active on other pages. Grayed elements are displayed by fading their image, that is to say reducing the image saturation of the appropriate area of screen.

In FIG. 6 the first listed element is the company logo element 27 which is to be positioned at position X=5, Y=5 on the page, it being noted that, in the embodiment, the X coordinate is measured from the left of the page and Y coordinate from the top of the page. The company logo element 27 is a static element. The next element is the printer home element 25, is to printed at position X=10, Y=85 and is also to be a static element. The third element on the page is the color/black ink element and is to be displayed at position X=55, Y=10 and is to be an active element, that is to say that it may be selected by a user and will cause an event to occur as will be described below. Likewise there are active elements positioned at defined places for the halftone element 60, the resolution options element 65 and the order supplies element 70.

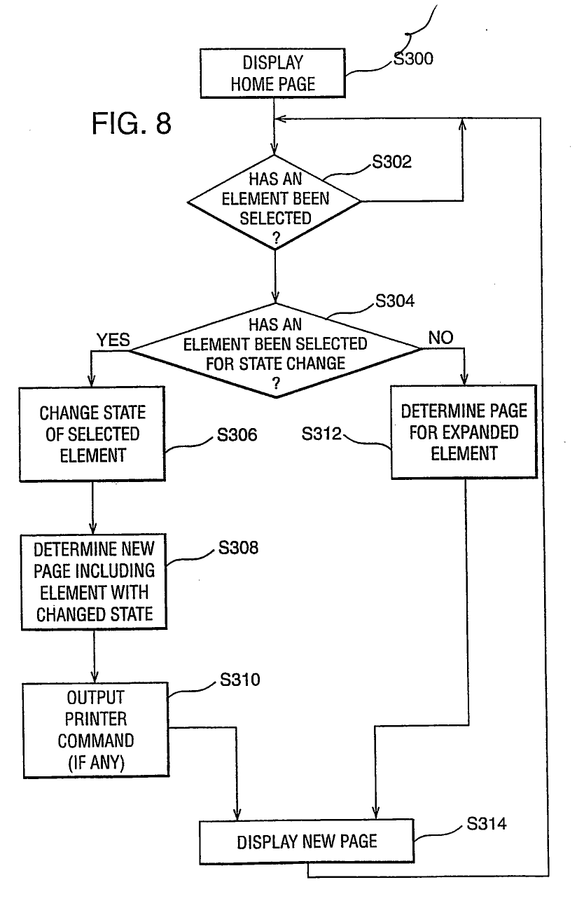

The working memory 210 of the I/O interface of the printer device 199 will now be described with reference to FIG. 7. An identification number of the present page, i.e. that currently displayed on the screen, is stored in a first memory location 211. In a second location 212, an identification number of the presently selected element is stored. Finally, in a third group of memory locations 213 one for each element, the current numeric state of each element is stored.

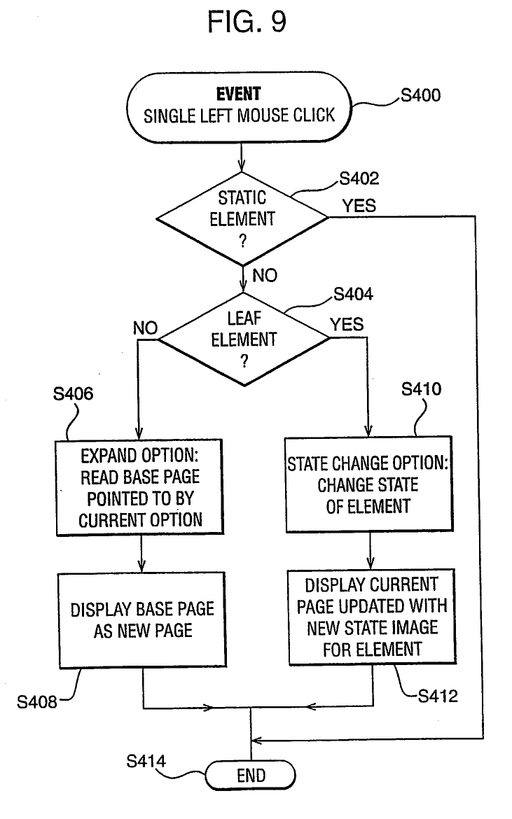

The operation of the I/O interface 200 of the printer driver 199 will now be described with reference to the flow diagram of FIG. 8. In step 300, the home page is read and displayed to the user on the VDU. In step 302, the I/O interface 200 detects whether the user has clicked on an image thus selecting an element. In the embodiment, the cursor 100 will change its appearance to the user so as to indicate that it lies above an element which may be activated (i.e. not above a static or grayed element or an unused portion of the screen).

Once the user has selected an element, in step 304 the I/O interface determines whether the type of selection is one indicating that the user wishes to change the state of the selected element, or instead whether the user requires expansion of the element to display the elements available further down the hierarchical structure. As will be described more fully below, the I/O interface 200 distinguishes between the above two possibilities in dependence upon the type of mouse button click (single left click, double left click or single right click). It also takes into account the relationship between the selected element and the presently displayed page (that is to say whether the selected element is a parent or child type element in relation to the other elements on that page).

In the case where the user has selected an element for a change of state, in step 306 the I/O interface 200 changes the state of that element and updates the working memory 213. The new state may be a single increment from the previous state (cycling round to the first state again if the previous state was the numerically highest state) or may be selected precisely by the user depending upon which of the mouse buttons were used to make the selection as will be described more fully below. In step 308, the I/O interface 200 determines how the display should be changed. This may require a new page to be displayed or merely the updating of the current page, fuller details of which are described below. In step 310, if there is a printer control command associated with the new state selected then this is output to the printer driver engine 230. The new or updated page is then displayed in step 314 and the page pointer 211 updated if necessary. The user interface then returns to step 302 to await the selection of the next element.

In the alternative situation where an element has been selected for expansion the process branches to step 312 where I/O interface determines the new page to be displayed which will be that which corresponds to the expanded element. This new page is determined by reading the base page details corresponding to the present state of the element from its element definition as will be described in greater detail below. The new page is then displayed at step 314 and the page pointer 211 is updated. The process then returns to step 302 as before.

In order to explain the above described process more fully, the process steps performed by the I/O interface upon three different categories of user selection of an element will now be described. These three categories are a single left mouse button click, a double left mouse button click and a single right mouse button click.

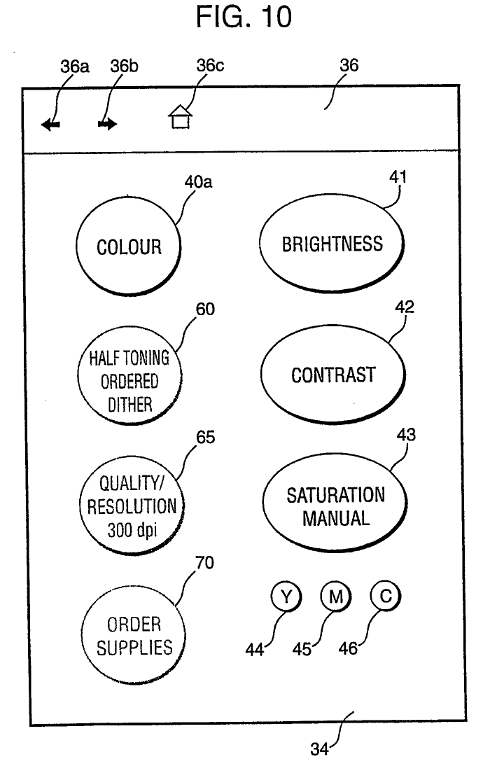

FIG. 9 shows the process steps carried out by the I/O interface upon the single click of the left mouse button on a selected element.

At step 400 the single click of the left mouse button is detected. At step 402, the I/O interface detects whether the cursor 100 lies over a static element. If it does lie over a static element (or a grayed element), the process branches to step 414 as the process is considered complete. If an active element has been selected, the process branches to step 404 where the I/O interface determines whether the selected element in its current state is a leaf element. This is achieved by reading the portion of the element definition 220 of the selected element corresponding to its presently selected state. If this state definition has no children then the element is a leaf element.

Describing first the situation where the element is not a leaf element, the flow branches to step 406. In step 406, the base page is read from the current state of the selected element. The page listed as the base page will contain the children of the element selected for expansion. once the new page to be displayed has been read, in step 408 this is displayed on the VDU and the page pointer 211 is updated.

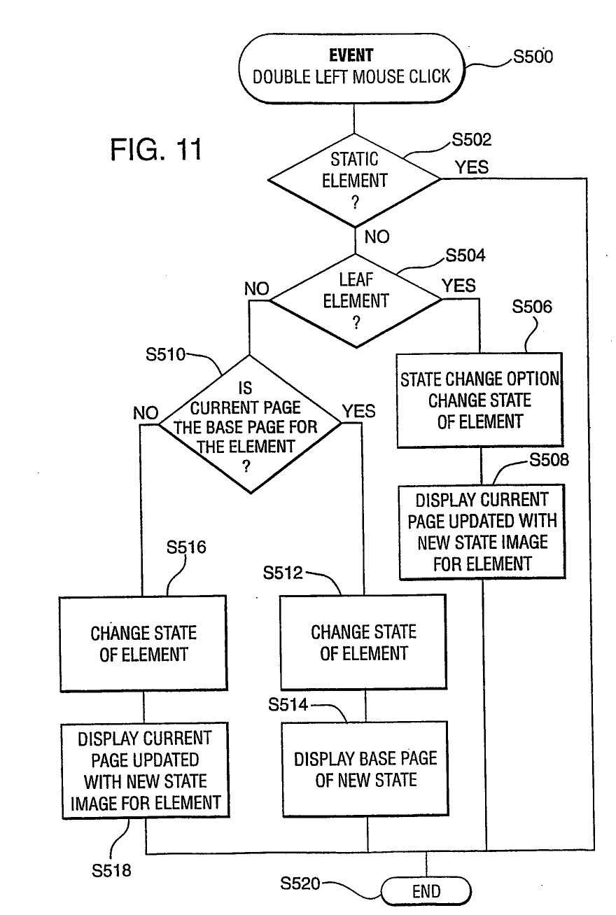

An example of the above operation, from the point of view of a user, will now be described. In this example, it is first assumed that the presently displayed page is the home page shown in FIG. 5. It is further assumed that the user has located cursor 100 to lie on top of color ink element 40a and has selected this using a single click of the left mouse button (step 400). Following the process described above, the I/O interface will read at step 404 the element definition for the ink options element (shown in FIG. 4) and thus determine that the presently selected state has children. The process will thus proceed to step 406 where the base page of the present state of the selected element will be read which, in this case is named ink-options-color. Thereafter the contents of the ink options color page (not shown) will be read and page will be displayed. In this case, a page corresponding to FIG. 10 will be displayed.

Explaining FIG. 10 in greater detail, tool bar 36 and browsing space 34 are as previously described. The four elements 40a, 60, 65, 70 on the right hand side of the browsing space 34 in FIG. 5 are now presented at the left of the browsing space 34. As an optional feature, a scrolling movement may be used to effect this. Children of the element 40a and, in this embodiment, grandchildren have now been displayed on the screen. Children brightness element 41 and contrast element 42 which are both leaf elements are displayed. Also displayed is saturation element 43 and (as manual saturation control is currently selected) grandchildren elements yellow 44, magenta 45 and cyan 46 are additionally displayed. As the selection of color is currently of interest to the user, the elements 60, 65 and 70 which remain on the browsing area in this example are grayed, meaning that they cannot be directly selected from the screen. As will be appreciated, a return to the home screen of FIG. 5 will be necessary in order to select these elements which can be achieved using the back arrows 36a or the home icon 36c. It should be noted that the parent page in the element definition allows the back arrow feature to be implemented.

Returning to FIG. 9, the process where the selected element is a leaf element will now be described. In such a event, the process will branch to step 410. In this case the user will have selected the element in order to change its state. The user interface, therefore, reads the current state of the selected element from the state definition block 213. This is then incremented by one to the next numerically higher state. In the event that the numerical value of the state exceeds the number of possible states, it is reset to state zero. Thus the state selection is cyclic in nature. As will be apparent, in the case of an element having only two states, this effectively achieves a toggling between the two states. The numerical value of the new state is then stored in the appropriate memory location 213. In step 412, the appearance of the new page is determined. The page to be displayed is already known and stored in location 211. As previously described, that page definition includes the position of all the elements. However, as a state change has occurred, an updated image must be displayed corresponding to the selected element. This is read from the state ribbon of the selected element. As previously described, this state ribbon contains a series of sequential images, one for each numeric value of the state. In this manner, the. page definition defining the elements to be displayed will be updated to display the image of the element in the presently selected state. The process also determines, from the current state portion of the selected element whether an action is to be performed and, if so, performs that action. The process ends at step 414.

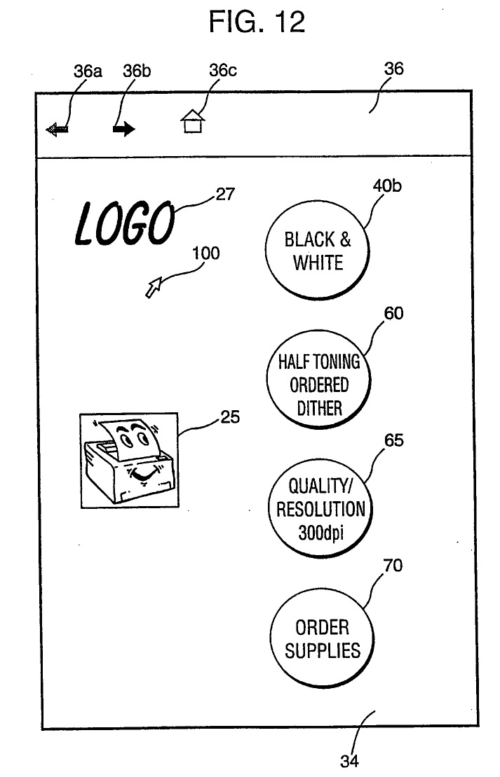

The process steps when an element has been double clicked using the left mouse button will now be described with reference to FIG. 11. This is commenced at step 500 by the left mouse button double click. At step 502 it is detected whether the element is static (or grayed) and if so the flow branches to step 520 where the process ends. otherwise, at step 504 it is detected whether the element is a leaf element or not in the manner previously described. If the element is a leaf element, then its state is changed at step 506, and updating performed in the same manner as that employed for a leaf element when a single click has occurred which will not, therefore be explained again.

In the event that the selected element is not a leaf element, the flow branches to step 510 where it is detected whether the current page is the base page for the element. This is necessary because an element may be displayed either with its parent or its children. In the event that it appears with its children it will be necessary to change the page with the change of state so as to display the new children. On the other hand, if the selected element appears with its parent it is only necessary to update the page with the new state of the selected element. The processes by which these two options are achieved will be described in greater detail below.

In order to determine whether the current page is the base page for the selected element, the user interface reads the base page from the element definition of current state of the selected element and compares this with the present page stored at memory location 211. In the event that the current page is not the base page, the process branches to step 516 and increments the state of the element. As previously explained, it is cycled to state zero if necessary. In step 518, the current page is updated with the new state image for the element using. the state ribbon for the new state as previously described.

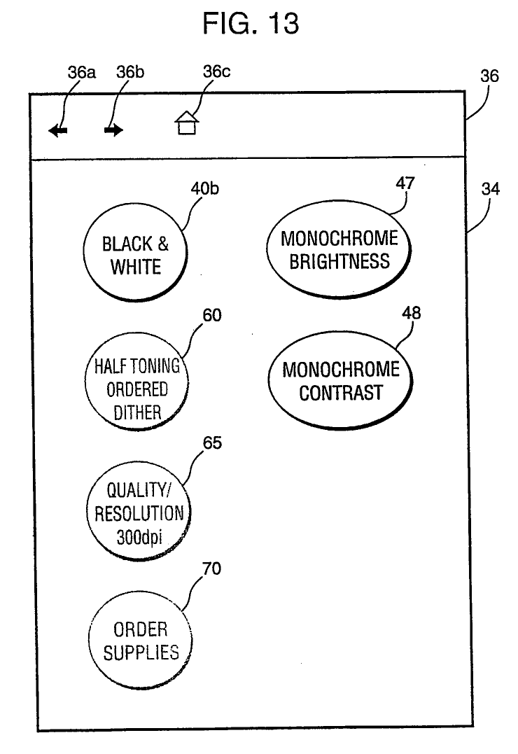

Again using the home page shown in FIG. 5 as an example this process will be described as it appears to a user. In this case, a double click on color ink element 40a is an indication that the user wishes to change the state of this element rather than expanding it. The process will have branched to step 510 where it will have determined that the present page does not correspond to the base page of the selected element (see reference numeral 130 of FIG. 4). The process will thus have branched to step 516 where the state of the element is changed. In this case there are only two states and so this state is cycled to state zero. The image for the element is read from the state ribbon and the updated page is then displayed on the browsing space 34 of the VDU. FIG. 12 shows the displayed output on the VDU following the above process.

As shown in FIG. 12, the displayed output is similar to that of FIG. 5 except that a black ink element image 40b is displayed instead of the color image element 40a. As will be appreciated, the expansion of black ink element 40B will subsequently give different children options to those which would have been presented had the alternative state of color image of 40a been selected.

Returning to FIG. 11, if at step 510 it is determined that the page is the base page for the element then the process branches to step 512 where the state of the element is incremented in the same manner as described above. In this case, however, the new base page for the new page is read from the state information of the selected element and it is this new base page which is displayed. The page pointer 211 is updated accordingly. The process thereafter terminates at step 520.

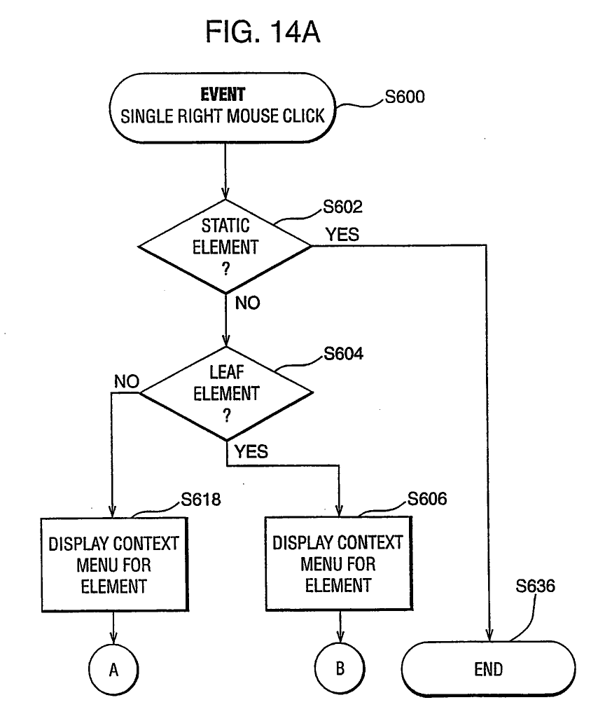

Using the page displayed in FIG. 10 as an example the above process as it would appear to a user will now be described. It is assumed that the user has double left clicked on color image element 40a. It will be appreciated that the current page will be the base page for that selected element. The process of FIG. 11 will thus have branched to step 512 and changed the state of the ink options element to black ink (state 0). The new base page will have been read and displayed. This will result in a user display as shown in FIG. 13.

FIG. 13 shows tool bar 36 and browsing space 34 as previously described. To the left of browsing space 34 now appears black ink element 40b (in place of color ink element 40a) below which are grayed halftoning element 60, quality/resolution element 65 and order supplies element 70 as before. On the right of the browsing space 34 are the two children of black ink element 40b namely monochrome brightness 47 and monochrome contrast 48 which replace the children of the color ink element 40a.

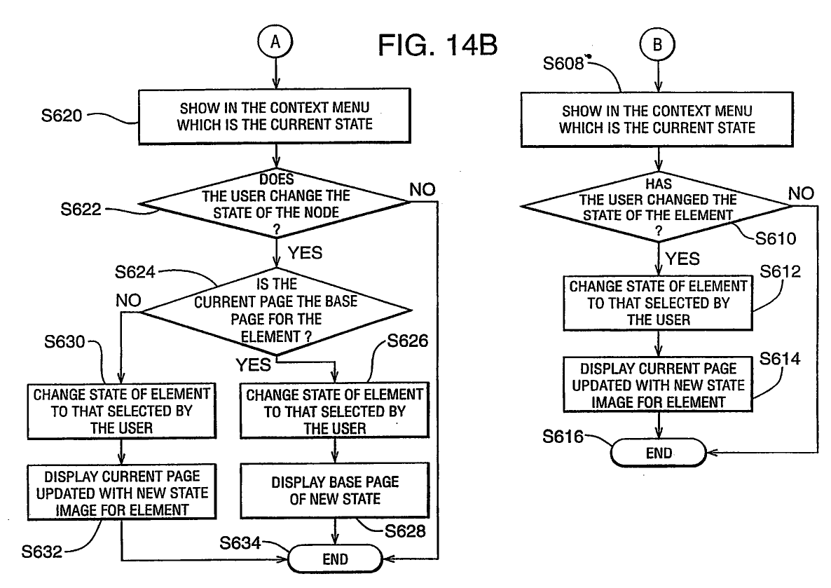

The actions performed by a click of the right mouse button will now be described with reference to FIGS. 14A and 14H. In overview, however, a similar process is followed to that of a single left mouse click except that instead of the present state of the element being incremented by a single state, the user may select the new state of the element from a list of all possible states using the mouse. In the embodiment, the current state of the element is indicated by a tick adjacent to it.

Referring to FIG. 14A at step 600 a single right click of the mouse button is determined. At step 602, it is determined whether the element selected is a static element in which case the process ends at step 636. otherwise, at step 604 it is determined whether the selected element is a leaf element. The manner of this detection has been previously described and will not be repeated.

If the element is a leaf element, the process branches to step 606 where the context menu. for that element is displayed. A context menu is a portion of the displayed screen which temporarily over writes the previous image and contains a list of all possible states for that element. In a modification, however, the space allocated to the context list may be of predetermined size and may be scrollable if the number of state images are too great although this is considered non-preferable. continuing to FIG. 14H, the context menu is highlighted so as to indicate the current state. In the embodiment this is by means of a tick adjacent to the image but other forms of such indications could be used (e.g. by making the image flash or larger than the other state images). At step 610 it is detected whether the user wishes to change the state of the element. The user does this change by moving the cursor to the desired new state and confirming the selection by clicking a mouse button, this being a known procedure for choosing an item from a menu. If the user does not change the state of a element then the process ends at step 616. If the user does change the state of the element then updating steps (steps 612 and 614) as previously described with reference to a left mouse button click are performed. At step 6.16 the process terminates.

Returning to step 604, if the element is not a leaf element then a context menu for the selected element is displayed at step 618 in a similar manner to the context menu of a leaf element. Again current state of the element is indicated in step 620 using a tick adjacent to the current state of the element. At step 622 it is determined whether the user wishes to change the state of the element and if no change is required, the process branches to step 634 and the process ends. Otherwise, the process branches to step 624 where it is determined whether the current page is the base page for the element in the same manner as that previously described (see step 510, FIG. 11). If the current page is not the base page for the element then the state of the element is changed to that selected by the user (step 630) and the current page updated with the new state image for the element is displayed at step 632 using the state ribbon information as previously described. The process thereafter ends at step 634. Conversely if at step 624 it is determined that the current page is the base page for the element then the state of the element is changed to that specified by the user at step 626 and, at step 628, the base page of the new state is displayed. This is done in the same manner as described above. The process thereafter ends at step 634.

The other options presented in the tree diagram of FIG. 3 will not be discussed in detail as the architecture and functionality is the same as that described above. However, with reference to element 70, it will be appreciated that the printer device driver can be used in conjunction with a modem in order to place orders directly with a supplier for consumables such as paper, ink cartridges or the like. Furthermore, the architecture of the present invention allows the images of these elements to look like the consumables on offer. Thus the user may be presented with a picture of a color ink jet cartridge and, merely by clicking on that cartridge, will be able to forward the selected article. Indeed, the architecture of the present invention will allow an original equipment manufacturer to personalize the device driver so as to maintain a house style with its products and its website.

In the embodiment, a driver for a color ink jet printer was described. The invention may, however, be used to drive any type of printer such as ink jet printers in general, laser printers, dye sublimation printers or thermal wax transfer printers.

In the embodiment, a printer driver was described. The invention is, however, suitable for all types of device drivers and could, therefore, be employed in device drivers for modems, scanners, monitors or the like.

In the embodiment described above, a state ribbon has been used in order to define the images corresponding to each state of an element. This need not be the case and the state definition portion of each element could contain the image information. An advantage with the state ribbon is simplicity but there is a disadvantage that all of the images must be of the same size. The use of individually defined images for each state allows different size images to be used for different states.

In the embodiment, a single image has been displayed to represent and indicate the state of an element. However the invention is not so limited and the displayed image may, in fact, be animated and thus comprise a series of images so as to present a moving image to the user. Additionally sound may accompany the image. Alternatively the image representing the state of an element could be handled by a “plug in” which is an external piece of software which functions or appears to function as an integral part of the system and takes the responsibility for implementing a plurality of additional features for an on behalf of the system, those features appearing to the user as if they were provided by the system itself.

In the embodiment specific events have been triggered by specific mouse button clicks. The described relationship is not intended to be limiting and other mouse events could be tied to the triggered event. Furthermore a three button or wheel-mouse could be used as could any other type of pointing device.

In the embodiment, the size of each image to be displayed is dependent upon the stored bit image. However, it would be possible to include a scaling parameter into the element definition so that the same bit image could be used for different pages but displayed in different sizes. For example, when the element is a parent the size could be larger than when it is a child. Scaling of images may also be necessary in order to improve the presentation of the elements on a page.

A further modification is the introduction of a cursor which can be customized. As previously explained, it is known to change the appearance of the cursor from a first appearance when it does not lie over. An activatable element to a second appearance when it does lie over an activatable element. A new image for the cursor when it lies over an activatable element could be stored in the element definition. This would allow a different cursor to appear dependent upon what type of element the cursor was lying over. An example of a suitable element would be an ink pot when the cursor lay over the ink options element.

A further alternative is the provision of a tool known as an agent within the printer driver. Agents are an enhanced interface between a user and system help information but are not currently in use in device drivers. Agents may take the form of an animated character to whom users may ask questions in a natural language in order to obtain technical information and help on the system. In the case where the invention is embodied in a printer driver, a suitable agent would be a character constructed from a simplified stylized image of a printer.

In a further modification to the embodiment, the printer driver would monitor the remaining amount of consumables, such as the amount of ink or paper. Monitoring could be carried out by the printer being capable of sending consumables depletion messages to the driver. upon the remaining amount of consumables falling below a preset amount, the printer driver would cause a prompt to be displayed to the user requesting the user to indicate whether a replacement consumable should be ordered. In a further alternative, the driver could order a replacement consumable automatically, without the need for user confirmation. In a further alternative, the driver could cause an order form to be generated and printed by the printer. The order could then be sent by conventional mailing service to the service location. Further, the “order supplies” element 70 could have a i child element depending therefrom, selection of which causes presentation of an options interface to a user, so that the user can enter details of a supplier of the printer consumables.

In a further modification, the driver would keep a record of the age of the driven printer and would call the attention of the user to new products after a predetermined passage of time (e.g. two years). Information on these new products would be downloaded from the Internet.

In the embodiment, each display screen consists of parents on the left of the browsing space and children on the right allowing a left to right scrolling effect to be performed upon navigation through the elements. However, this need not be the case and the image representing the home element or the present parent could be in the centre of the browsing space with the children arranged in a circular fashion around it. In fact, any type of page display may be achieved merely by customization of the page data.

In the above description, elements having one state have not been described in detail. one state elements would be leaf elements which perform a single function, e.g. nozzle cleaning. The selection of an element would cause the I/O interface 200 to instruct the printer driver 230 directly to perform the function.

Other modifications and variations will be apparent to those skilled in the art.

What is claimed is:

1. A device driver for generating control commands for driving a peripheral, the device driver comprising:
a status store configured to store state data identifying a current state for each of a number of functions of a peripheral;
a driver engine operable to generate control commands for driving a peripheral in accordance with state data stored in said status store; and
a user interface generation module for generating display data defining graphical user interface displays in dependence upon data stored in said status store and responsive to user selection of graphical elements in generated user interface displays to update data stored in said status store; wherein
said user interface generation module comprises:
(i) a graphics store configured to associate each state of each of said number of functions of a peripheral with an item of graphics data defining a graphical element;
(ii) a page store configured to store a user interface template, comprising layout data defining an arrangement of place markers for graphical elements of a display and data associating at least some of said place markers with functions of a peripheral; and
(iii) a display data generation module responsive to the updating of data in said status store to generate display data defining a graphical user interface display wherein said graphical user interface display comprises graphical elements defined by graphics data associated with states identified by state data in said status store for functions associated with place markers by the user interface template, said graphical elements being arranged in accordance with the layout data of said user interface template.

2. A device driver in accordance with claim 1, wherein said page store is configured to store a plurality of user interface templates each comprising layout data defining an arrangement of place markers for graphical elements and data associating at least some of said place markers with functions of a peripheral, said display data generation module being operable to select a user interface template of said plurality of user interface templates and generate display data defining a graphical user interface display comprising graphical elements defined by data associated with states identified by state data in said status store for functions associated with place markers by the selected user interface template, said graphical elements being arranged in accordance with the layout data of the selected user interface template.

3. A device driver in accordance with claim 2 wherein said display generation module further comprises
a current page store configured to store data identifying a currently selected user interface template, said display generation module being responsive to updating data in said status store or said current page store to generate display data defining a graphical user interface utilizing the user interface template identified by data stored in said current page store.

4. A device driver in accordance with claim 2 wherein said user generation module is responsive to user selection of some graphical elements in generated user interface display to vary the selected user interface template for generating display data.

5. A device driver in accordance with claims 2, wherein said graphics store is further configured to store additional items of graphics data, said page store being configured to store user interface templates further comprising data associating some place markers defined by layout data with said additional items of graphics data in said data store, said display data generation module being operative to generate display data defining graphical interface displays including graphic elements defined by additional items of graphics data associated with said place markers arranged in accordance with the layout data including said place markers.

6. A device driver in accordance with claim 5 wherein at least some of said additional items of graphics data are associated with data identifying a user interface template, said user interface generation module being responsive to user selection of graphic elements corresponding to said items of graphics data to vary said selected user interface template in accordance with the data associated with said graphics data corresponding to said selected graphical elements.

7. A device driver in accordance with claim 6 wherein said graphics store is operable to store an item of graphics data associated with the selection of a default user interface template, said user interface generation module being responsive to user selection of a graphic element corresponding to said item of graphics data to set said selected user interface template to be said default user interface template.

8. A device driver in accordance with claim 6 further comprising
a sequence store operable to store data identifying a sequence of user interface templates, wherein said graphics store is operable to store one or more items of graphics data associated with changing a selected user interface template, said user interface generation module being responsive to user selection of graphic elements corresponding to said items of graphics data to set as said selected user interface template a user interface template in said sequence of user interface templates.

9. A device driver in accordance with claim 1,
wherein said driver engine comprises a driver engine operable to generate control instructions for driving a printer.

10. A computer apparatus comprising:
a device driver in accordance with claim 1; and
a display responsive to generation of display data by said display data generation module to display graphical user interface displays defined by said generated display data.

11. Apparatus in accordance with claim 10, further comprising a signal generator operable to generate a communication signal for communicating with a remote location, and responsive to user selection of an identified graphical element in a generated user interface display to generate a signal for procuring a consumable product of a peripheral device with which the device driver is operative to communicate in use.

12. Apparatus in accordance with claim 11, wherein said device driver is responsive to a signal input from a peripheral representative of a depletion of a consumable to cause said signal generator to generate said consumable procuring signal.

13. A method of generating control commands for driving a peripheral, comprising:
storing state data identifying a current state for each of a number of functions of peripherals;
generating display data defining a graphical user interface display independence upon said stored state data by:
storing an item of graphics data defining a graphical element in association with each of said number of functions of a peripheral;
storing a user interface template comprising layout data defining an arrangement of place markers for graphical elements in a display at least some of said place markers being associated with functions of said peripheral; and
generating display data defining a graphical user interface comprising graphical elements defined by graphics data associated with states identified by said stored state data for functions associated with the place markers by said user interface template, the graphical elements being arranged in accordance with the layout data of said user interface template;
updating said stored state data in response to user selection of graphical elements in a generated user interface display generated using utilizing said display data; and generating control commands for driving a peripheral in accordance with said updated state data.

14. A method in accordance with claim 13 further comprising:
storing a plurality of user interface templates each comprising layout data defining an arrangement of place markers for graphical elements and data associating at least some of said place markers with functions of a peripheral, wherein said generation of display data comprises:
(i) selecting a user interface template of said stored plurality of user interface templates and
(ii) generating display data defining a graphical user interface display comprising graphical elements defined by data associated with states identified by stored state data for functions associated with place markers by the selected user interface template, said graphical elements being arranged in accordance with the layout data of said selected user interface template.

15. A method in accordance with claim 14 further comprising:
storing data identifying a currently selected user interface template; and generating display data in response to updating said stored status data or said data identifying the current selected user interface template.

16. A method in accordance with claim 14 further comprising:
responding to user selection of some graphical elements in a generated user interface display by varying the selected user interface template for generating display data.

17. A method in accordance with claim 14 further comprising:
storing additional items of graphics data, wherein at least some of said stored user interface templates include data associating some place markers defined by layout data with said additional items of graphics data, said generation of display data comprising generating display data defining graphical user interface displays including graphics elements defined by said graphics data associated with place markers arranged in accordance with the layout data including said place markers.

18. A method in accordance with claim 17 further comprising:
associating at least some of said additional items of graphics data with data identifying a change of selected user interface template; and
responding to user selection of graphic elements corresponding to said items of graphics data to vary said selected user interface template in accordance with said data associated with said graphics data corresponding to said selected graphical elements.

19. A method in accordance with claim 18 further comprising:
responding to user selection of a graphic element corresponding to an item of graphics data associated with a default user interface template by setting said selected user interface template to be said default user interface template.

20. A method in accordance with claim 18 further comprising:
storing data defining a sequence of user interface templates; and
responding to selection of items of graphics data associated with changing a selected user interface template by setting said current user interface template as a user interface template in said sequence of user interface templates.

21. A method in accordance with claim 13 wherein said generation of control commands for driving a peripheral comprises generating control instructions for driving a printer.

22. A method in accordance with claim 13 further comprising:
displaying a graphical user interface display defined by said generated display data.

23. A method in accordance with claim 13 further comprising:
responding to user selection of an identified graphical element in a generated user interface display by generating a signal for procuring a consumable product of a peripheral device for which control commands are being generated.

24. A storage medium carrying computer readable commands for causing a programmable computer to perform a method in accordance with claim 13.
